(19) United States
(12) Patent Application Publication
(10) Pub. No.: US 2015/0224987 A1
(43) Pub. Date: Aug. 13, 2015

(54) TRAVEL ASSISTANCE SYSTEM AND CONTROL DEVICE

(71) Applicants: Akihide TACHIBANA, (US); TOYOTA JIDOSHA KABUSHIKI KAISHA, Toyota-shi, Aichi-ken (JP)

(72) Inventor: Akihide Tachibana, Susono-shi (JP)

(73) Assignee: TOYOTA JIDOSHA KABUSHIKI KAISHA, Toyota-shi, Aichi-ken (JP)

(21) Appl. No.: 14/429,091

(22) PCT Filed: May 21, 2013
(86) PCT No.: PCT/JP2013/064121

§ 371 Date: Mar. 18, 2015

(30) Foreign Application Priority Data
Oct. 12, 2012 (JP) 2012-227174

(51) Int. Cl. B60W 30/09

(52) U.S. Cl. CPC B60W 30/09

(57) ABSTRACT

A travel assistance system includes: an actuator of a vehicle; and a control device configured to control the actuator of the vehicle, to assist travel of the vehicle, based on a moving object avoidance trajectory obtained by enlarging, in a travel direction of the vehicle, a basic avoidance trajectory for the vehicle to travel while avoiding an obstacle according to a relative speed of the vehicle with respect to the obstacle.

### FIELD

The present invention relates to a travel assistance system and a control device.

### BACKGROUND

As a conventional travel assistance system and a control device mounted on a vehicle, Patent Literature 1 discloses a travel path generating device which generates a plurality of candidates of a moving trajectory which an obstacle might follow, for example. The travel path generating device calculates a travel path of an own vehicle along which the own vehicle may avoid contact with the obstacle when the obstacle moves along the moving trajectory for each generated candidate of the moving trajectory. The travel path generating device selects an optimal travel path from a plurality of calculated travel paths.

### CITATION LIST

### Patent Literature

Patent Literature 1: Japanese Laid-open Patent Publication No. 2010-228740

### SUMMARY

### Technical Problem

The travel path generating device disclosed in Patent Literature 1 described above has a room for further improvement in more appropriate travel assistance because, for example, it has complicated generation logic of the moving trajectory and a large calculation load.

The present invention is achieved in view of the above-described circumstances and an object thereof is to provide the travel assistance system and the control device capable of appropriately performing the travel assistance.

### Solution to Problem

To achieve the object, a travel assistance system according to the present invention includes: an actuator of a vehicle; and a control device configured to control the actuator of the vehicle, to assist travel of the vehicle, based on a moving object avoidance trajectory obtained by enlarging, in a travel direction of the vehicle, a basic avoidance trajectory for the vehicle to travel while avoiding an obstacle according to a relative speed of the vehicle with respect to the obstacle.

Moreover, in the above-described travel assistance system, the control device is configured to make the moving object avoidance trajectory relatively long in the travel direction of the vehicle as an absolute value of the relative speed is relatively small at a time the vehicle approaches the obstacle.

Moreover, in the above-described travel assistance system, the control device is configured to generate the moving object avoidance trajectory by enlarging the basic avoidance trajectory according to a vehicle speed of the vehicle and the relative speed.

Moreover, in the above-described travel assistance system, the control device is configured to make the moving object avoidance trajectory relatively long in the travel direction of the vehicle as the vehicle speed of the vehicle is relatively high at a time the vehicle approaches the obstacle.

Moreover, in the above-described travel assistance system, the control device is configured to generate the moving object avoidance trajectory based on behavior of the obstacle before the basic avoidance trajectory has been generated.

Moreover, in the above-described travel assistance system, the control device is configured to generate the basic avoidance trajectory again and generate the moving object avoidance trajectory again based on the basic avoidance trajectory generated again at a time a change amount of the behavior of the obstacle becomes not smaller than a change amount threshold set in advance while controlling the actuator of the vehicle based on the moving object avoidance trajectory to assist the travel of the vehicle.

Moreover, in the above-described travel assistance system, the control device is configured to generate the moving object avoidance trajectory such that an interval between the vehicle and the obstacle becomes relatively wide in a direction intersecting with the travel direction of the vehicle as the absolute value of the relative speed is relatively small when the vehicle approaches the obstacle.

Moreover, in the above-described travel assistance system, the control device is configured to change the moving object avoidance trajectory based on whether or not a travel road in the travel direction of the vehicle is a curved road.

Moreover, in the above-described travel assistance system, the control device is configured to stop assisting the travel of the vehicle based on the moving object avoidance trajectory at a time presence of an oncoming vehicle traveling so as to be opposed to the vehicle is predicted on the moving object avoidance trajectory.

Moreover, in the above-described travel assistance system, the control device is configured to generate the moving object avoidance trajectory such that a closest position of the obstacle to the vehicle predicted based on the behavior of the obstacle and a peak position of an avoidance trajectory along which the vehicle avoids the obstacle are equivalent positions in the travel direction of the vehicle.

Moreover, in the above-described travel assistance system, the control device is configured to generate the moving object avoidance trajectory such that a starting position of an upward gradient of the travel road in the travel direction of the vehicle and an avoidance completing position of the obstacle by the vehicle are equivalent positions in the travel direction of the vehicle.

Moreover, in the above-described travel assistance system, the control device is configured to generate the basic avoidance trajectory based on a momentary positional relationship between the vehicle and the obstacle before the moving object avoidance trajectory is generated.

To achieve the object, a control device according to the present invention is configured to control a vehicle, to assist travel of the vehicle, based on a moving object avoidance trajectory obtained by enlarging, in a travel direction of the vehicle, a basic avoidance trajectory for the vehicle to travel while avoiding an obstacle according to a relative speed of the vehicle with respect to the obstacle.

### Advantageous Effects of Invention

The travel assistance system and the control device according to the present invention have an effect of appropriately performing the travel assistance.

### BRIEF DESCRIPTION OF DRAWINGS

FIG. 1 is a schematic configuration diagram of a vehicle to which a travel assistance system according to a first embodiment is applied.

FIG. 2 is a schematic diagram illustrating travel assistance based on a momentarily generated trajectory.

FIG. 3 is a schematic diagram illustrating the travel assistance based on an event trajectory.

FIG. 4 is a schematic diagram illustrating an example of generation of a sequential trajectory.

FIG. 5 is a schematic diagram illustrating an example of generation of the event trajectory.

FIG. 6 is a schematic diagram illustrating an example of steering control.

FIG. 7 is a flowchart illustrating an example of control by an ECU of the travel assistance system according to the first embodiment.

FIG. 8 is a schematic diagram illustrating operation of the travel assistance system according to the first embodiment.

FIG. 9 is a schematic diagram illustrating an example of generation of a sequential trajectory in a travel assistance system according to a second embodiment.

FIG. 10 is a schematic diagram illustrating an example of generation of an event trajectory in the travel assistance system according to the second embodiment.

FIG. 11 is a flowchart illustrating an example of control by an ECU of the travel assistance system according to the second embodiment.

FIG. 12 is a schematic diagram illustrating an example of an event trajectory in a travel assistance system according to a third embodiment.

FIG. 13 is a schematic diagram illustrating an example of the event trajectory in the travel assistance system according to the third embodiment.

FIG. 14 is a schematic diagram illustrating an example of generation of an event trajectory in a travel assistance system according to a comparative example.

FIG. 15 is a schematic diagram illustrating an example of generation of an event trajectory in a travel assistance system according to a fourth embodiment.

FIG. 16 is a schematic diagram illustrating an example of generation of an event trajectory in a travel assistance system according to a fifth embodiment.

### DESCRIPTION OF EMBODIMENTS

Embodiments according to the present invention are hereinafter described in detail with reference to the drawings. Meanwhile, the present invention is not limited by the embodiments. Components in the following embodiments include a component easily replaced by one skilled in the art or a substantially identical component.

### First Embodiment

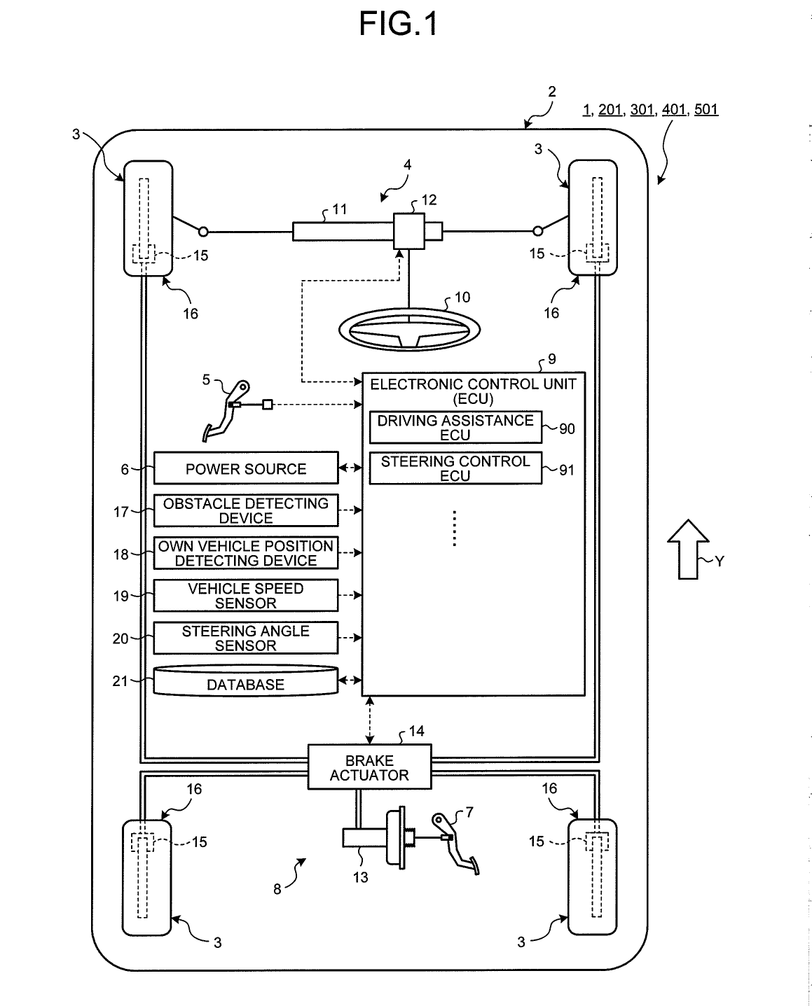

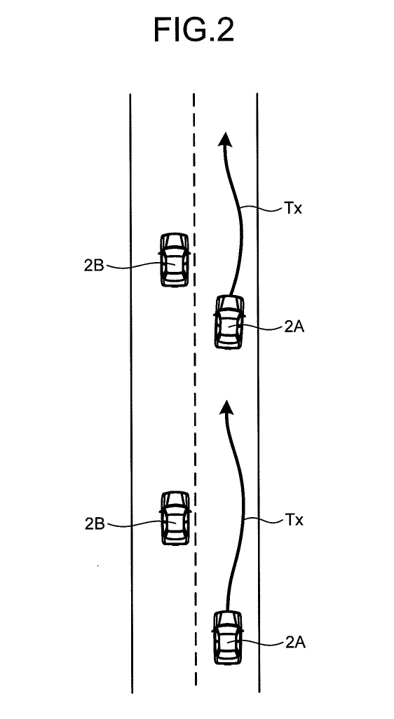

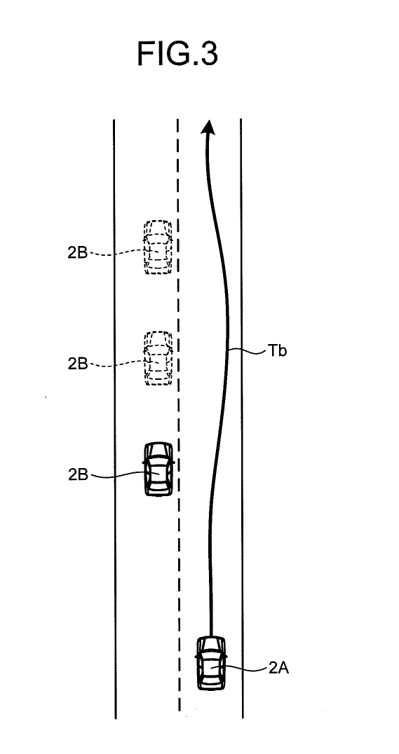

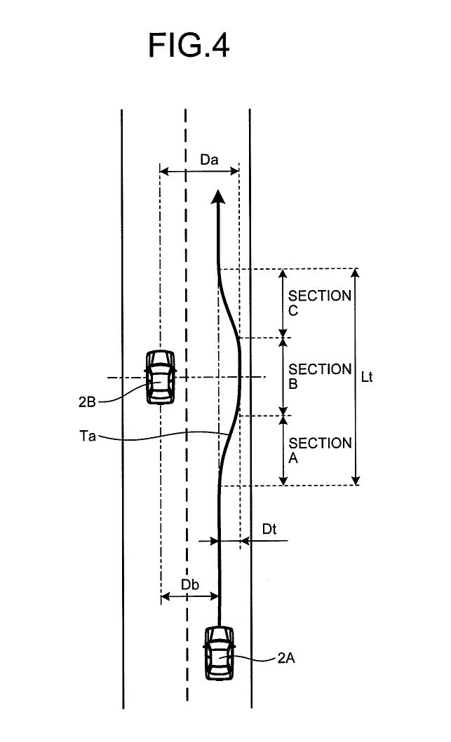

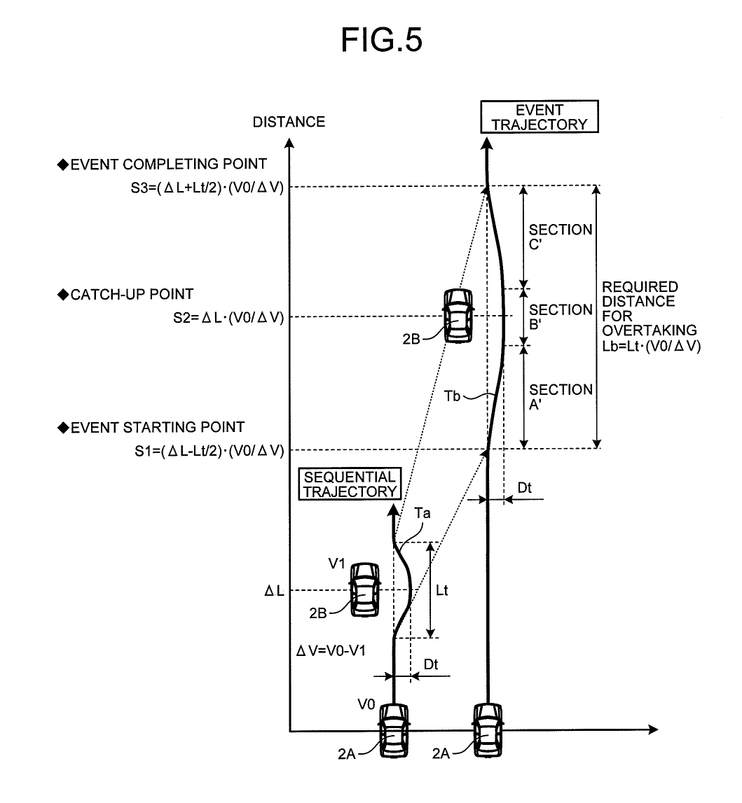

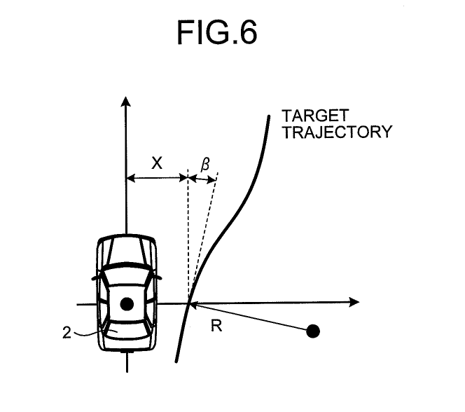

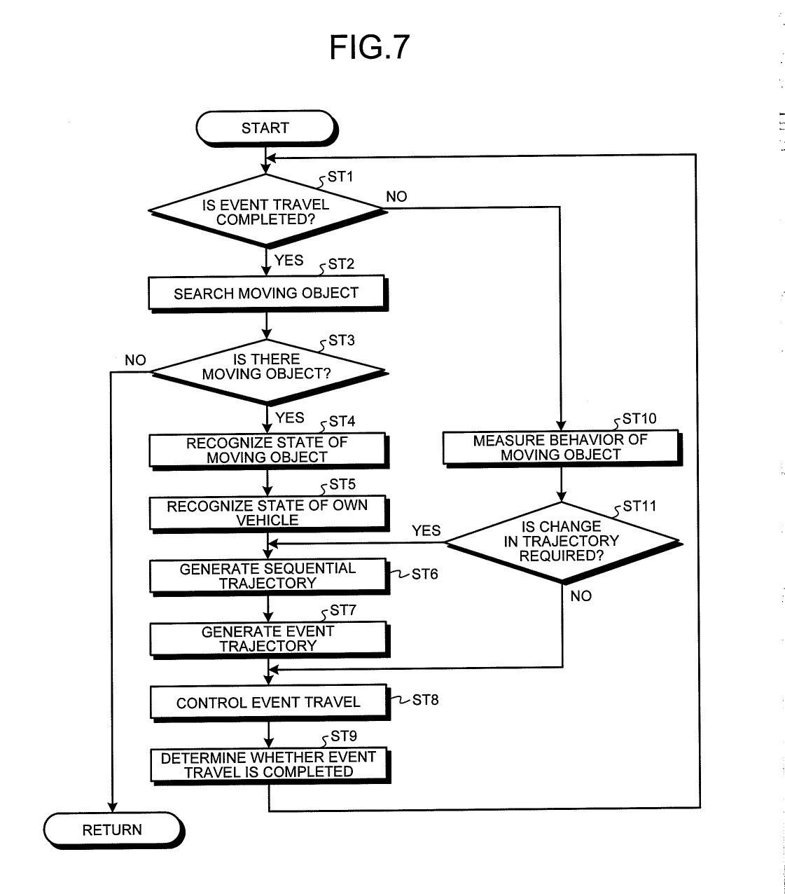

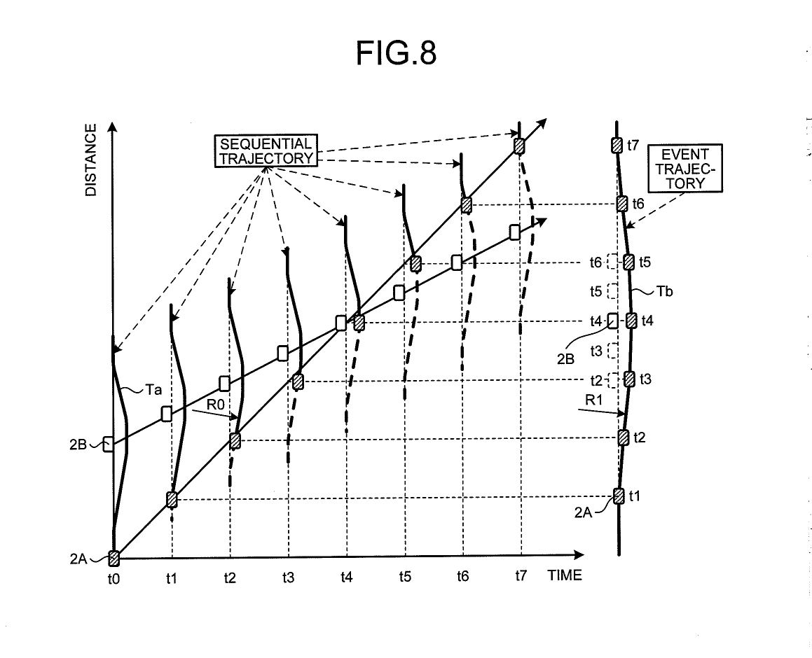

FIG. 1 is a schematic configuration diagram of a vehicle to which a travel assistance system according to a first embodiment is applied. FIG. 2 is a schematic diagram illustrating travel assistance based on a trajectory generated every moment. FIG. 3 is a schematic diagram illustrating the travel assistance based on an event trajectory. FIG. 4 is a schematic diagram illustrating an example of generation of a sequential trajectory. FIG. 5 is a schematic diagram illustrating an example of generation of the event trajectory. FIG. 6 is a schematic diagram illustrating an example of steering control. FIG. 7 is a flowchart illustrating an example of control by an ECU of the travel assistance system according to the first embodiment. FIG. 8 is a schematic diagram illustrating operation of the travel assistance system according to the first embodiment.

A travel assistance system 1 of this embodiment is mounted on a vehicle 2 as illustrated in FIG. 1. Herein, a direction of forward movement of the vehicle 2 is indicated by an arrow Y in FIG. 1. The direction in which the vehicle 2 moves forward is a direction from a driver's seat on which a driver of the vehicle 2 sits toward a steering wheel. Right and left sides are defined based on the direction in which the vehicle 2 moves forward (direction indicated by the arrow Y in FIG. 1). That is to say, “left” indicates the left side based on the direction in which the vehicle 2 moves forward and “right” indicates the right side based on the direction in which the vehicle 2 moves forward. A side in the direction in which the vehicle 2 moves forward is a front side of the vehicle 2 and a side in a direction in which the vehicle 2 moves rearward, that is to say, the direction opposite to the direction in which the vehicle 2 moves forward is a rear side of the vehicle 2.

The travel assistance system 1 of this embodiment is a driving assistance system which assists travel of the vehicle 2 by allowing the vehicle 2 to travel along a target trajectory. The term “travel assistance (driving assistance)” herein used may include so-called autonomous travel control and the like, for example. The travel assistance system 1 typically assists the travel of the vehicle 2 based on the target trajectory which is generated in a scene in which an own vehicle travels slightly rightward than usual for improving safety such as when the own vehicle overtakes a preceding vehicle or when this passes a side vehicle in an adjacent lane in steering assistance control, for example. At that time, the travel assistance system 1 of this embodiment controls the own vehicle not by the trajectory generated every moment (sequential trajectory) but by the trajectory generated based on an initially generated trajectory (event trajectory), thereby appropriately performing the travel assistance to satisfy both the safety and ride quality. The travel assistance system 1 is realized by components illustrated in FIG. 1 mounted on the vehicle 2. Meanwhile, in the following description, the vehicle 2 on which the travel assistance system 1 is mounted is sometimes referred to as the own vehicle.

Specifically, the travel assistance system 1 mounted on the vehicle 2 provided with a wheel 3 is provided with a steering device 4, an accelerator pedal 5, a power source 6, a brake pedal 7, a braking device 8, an electronic control unit (hereinafter, sometimes referred to as “ECU”) 9 as a control device and the like. The steering device 4, the power source 6, the braking device 8 and the like serve as an actuator of the vehicle 2. In the vehicle 2, the power source 6 generates power (torque) according to operation of the accelerator pedal 5 by the driver and the power is transmitted to the wheel 3 through a power transmitting device (not illustrated) to generate driving force on the wheel 3. In the vehicle 2, the braking device 8 operates according to operation of the brake pedal 7 by the driver, thereby generating braking force on the wheel 3.

The steering device 4 steers right and left front wheels out of four wheels 3 as steered wheels. The steering device 4 is provided with a steering wheel 10 being a steering operator by the driver and a turning angle applying mechanism 11 driven according to steering operation of the steering wheel 10. A so-called rack and pinion mechanism and the like provided with a rack gear and a pinion gear may be used, for example, as the turning angle applying mechanism 11 but the turning angle applying mechanism is not limited thereto. The steering device 4 is provided with a steering actuator 12 including a variable gear ratio steering mechanism (VGRS device) capable of changing a gear ratio of the steering wheel 10 and an electric power steering device (EPS device) which assists the operation of the steering wheel 10 by the driver by power of an electric motor and the like. The steering device 4 may change a steering angle of the steered wheel relative to a steering wheel steering angle (turning angle) being an operation amount of the steering wheel 10 according to a driving state of the vehicle 2 (for example, a vehicle speed being a travel speed of the vehicle 2) by the VGRS device, for example. The steering device 4 may also change the steering angle of the steered wheel irrespective of the steering operation by the driver by control of the steering actuator 12 by control of the ECU 9.

The power source 6 is the power source for travel such as an internal-combustion engine and the electric motor. The vehicle 2 may be any of a hybrid vehicle (HV) provided with both the internal-combustion engine and the electric motor as the power source for travel, a conventional vehicle provided with the internal-combustion engine but without the electric motor, an electric vehicle (EV) provided with the electric motor but without the internal-combustion engine and the like.

The braking device 8 may individually adjust the braking force generated on each wheel 3 of the vehicle 2. Various hydraulic brake devices in which a hydraulic path connecting a master cylinder 13 and a wheel cylinder 15 through a brake actuator 14 is filled with brake oil being working fluid serve as the braking device 8. In the braking device 8, a hydraulic braking unit 16 operates according to a braking pressure supplied to the wheel cylinder 15 to generate pressure braking force on the wheel 3. In the braking device 8, a wheel cylinder pressure is appropriately adjusted according to the driving state by the brake actuator 14. The brake actuator 14 individually adjusts the braking force generated on each wheel 3 by individually increasing, decreasing, and maintaining the wheel cylinder pressure of the four wheels.

The ECU 9 which controls driving of each unit of the vehicle 2 includes an electronic circuit mainly formed of a well-known microcomputer including a CPU, a ROM, a RAM, and an interface. To the ECU 9, various sensors and detectors are electrically connected, for example, and electric signals corresponding to detection results are input. The ECU 9 is electrically connected to each unit of the vehicle 2 such as the steering actuator 12 of the steering device 4, the power source 6, and the brake actuator 14 of the braking device 8 to output driving signals to them. The ECU 9 executes a stored control program based on various input signals input from the various sensors and detectors and various maps, thereby outputting the driving signals to each unit of the vehicle 2 such as the steering actuator 12 of the steering device 4, the power source 6, and the brake actuator 14 of the braking device 8 to control the driving of them.

The travel assistance system 1 of this embodiment is provided with an obstacle detecting device 17, an own vehicle position detecting device 18, a vehicle speed sensor 19, a steering angle sensor 20 and the like, for example, as the various sensors and detectors. The vehicle speed sensor 19 detects the vehicle speed of the vehicle 2 being the own vehicle. The steering angle sensor 20 detects the steering angle of the vehicle 2 being the own vehicle.

The obstacle detecting device 17 serves as an obstacle recognizing device. The obstacle detecting device 17 detects an obstacle around the vehicle 2 being the own vehicle. Herein, the obstacle typically is a moving object traveling in front of the own vehicle in a travel direction. The obstacle includes the preceding vehicle traveling in front of the own vehicle in an own vehicle travel lane in which the own vehicle travels in the same direction as that of the own vehicle, the side vehicle traveling in the adjacent lane of the own vehicle travel lane in the same direction as that of the own vehicle, an oncoming vehicle traveling in the adjacent lane of the own vehicle travel lane in a direction opposite to that of the own vehicle and the like, for example. In the following description, the preceding vehicle, the side vehicle, and the oncoming vehicle are collectively referred to as the moving objects unless otherwise noted. The obstacle detecting device 17 detects a relative speed of the own vehicle with respect to the moving object traveling in front of the own vehicle in the travel direction, a relative distance therebetween, a vehicle type (vehicle width and total length of the moving object) and the like, for example. The relative distance may include a relative distance in the travel direction between the moving object and the own vehicle in the travel direction, a lateral distance between the moving object and the own vehicle in a lateral direction intersecting with (orthogonal to) the travel direction and the like, for example. The obstacle detecting device 17 may use millimeter wave radar, radar using a laser, infrared ray and the like, close-range radar such as UWB (ultra wide band) radar, sonar using an audible acoustic wave or a ultrasonic wave, an image recognizing device which detects a situation in front of the vehicle 2 in the travel direction by analyzing image data obtained by imaging a front area in the travel direction of the vehicle 2 by using an imaging device such as a CCD camera, an inter-vehicular communication device and the like, for example.

The own vehicle position detecting device 18 serves as an own vehicle position recognizing device. The own vehicle position detecting device 18 detects a position of the vehicle 2 being the own vehicle. The own vehicle position detecting device 18 detects GPS information (coordinates of longitude and latitude) indicating the position of the own vehicle, a lateral distance between a white line of the lane in which the own vehicle travels and the own vehicle and the like, for example. The own vehicle position detecting device 18 may also use a GPS receiver, the image recognizing device which recognizes a white line position by analyzing the image data obtained by imaging the front area in the travel direction of the vehicle 2 by the imaging device such as the CCD camera and detects the lateral distance between the same and the own vehicle and the like, for example.

The travel assistance system 1 is provided with a database 21. The database 21 stores various pieces of information. Herein, the database 21 stores infrastructure information and the like. The infrastructure information includes at least one of map information including road information, intersection shape information and the like. For example, the road information includes at least one of road gradient information, road surface state information, road shape information, vehicle speed limit information, road curvature (curve) information, road lane information and the like. For example, the intersection shape information includes at least one of shape information of an intersection, stop position information at the intersection and the like. The shape information of the intersection includes crossroads, a T-junction, a Y-junction, an intersection with diagonal crosswalks, a rotary and the like, for example. The information stored in the database 21 is appropriately referred to by the ECU 9 and necessary information is read. The ECU 9 may calculate a travel point (current position) and the travel direction of the vehicle 2 based on the GPS information received by the own vehicle position detecting device 18 and the map information such as the road information stored in the database 21, for example. Meanwhile, although the database 21 is herein illustrated to be mounted on the vehicle 2, there is no limitation, and this may also be configured to be provided on an information center and the like outside the vehicle 2 to be appropriately referred to by the ECU 9 through a communicator and the like such that the necessary information is read.

The ECU 9 of this embodiment serves as a driving assistance control device which generates the target trajectory to control the vehicle. The ECU 9 assists the travel of the vehicle 2 by allowing the vehicle 2 to travel along the target trajectory. The ECU 9 generates a target travel trajectory based on the information detected by the various sensors and detectors and performs calculation processing such as the steering control. The ECU 9 typically generates the target trajectory for the own vehicle to travel while safely avoiding the moving object when the own vehicle overtakes the preceding vehicle, passes the side vehicle, and passes the oncoming vehicle. The ECU 9 generates the target trajectory being the target travel trajectory of the vehicle 2 based on a peripheral situation of the own vehicle detected by the obstacle detecting device 17, the own vehicle position detecting device 18 and the like, the infrastructure information stored in the database 21 and the like. Then, the ECU 9 controls the actuator of the own vehicle based on the generated target trajectory and assists the travel of the own vehicle. The ECU 9 controls the actuator such that an actual travel trajectory of the own vehicle converges to the above-described generated target trajectory. According to this, the travel assistance system 1 may assist the travel of the own vehicle such that the own vehicle travels along the target trajectory. As a result, the vehicle 2 may travel along the target trajectory for traveling while safely avoiding the moving object.

In the following description, the travel assistance system 1 is described as using the steering device 4 as the actuator capable of adjusting motion of the vehicle 2 to adjust the travel trajectory of the vehicle 2. The ECU 9 controls the steering device 4 to perform steering assistance such that the vehicle 2 may travel along the target trajectory. The ECU 9 controls the steering device 4 to adjust the steering angle of the vehicle 2, thereby adjusting the actual travel trajectory of the vehicle 2 to assist the travel of the vehicle 2 such that this converges to the above-described generated target trajectory. Meanwhile, the travel assistance system 1 may also use the power source 6, the braking device 8, a transmission (not illustrated) and the like as the actuator capable of adjusting the travel trajectory of the vehicle 2. In this case, the ECU 9 may control the power source 6, the braking device 8, and the transmission to adjust the driving force, the braking force, or a transmission ratio of the vehicle 2, thereby adjusting the actual travel trajectory of the vehicle 2 to assist the travel of the vehicle 2.

When the ECU 9 generates the target trajectory every moment for each control period according to the peripheral situation changing every moment, for example, this generates the target trajectory each time according to the change in the peripheral situation, so that a calculation load might become relatively large. In this case, the ECU 9 calculates and generates the target trajectory which is eventually not used, so that there is useless calculation and efficiency might be deteriorated in terms of the calculation processing. When the ECU 9 should always perform such inefficient calculation processing, excessively high-performance and high-cost hardware might be required for processing another function in parallel, for example.

Therefore, the travel assistance system 1 of this embodiment controls an own vehicle 2A not by making a trajectory Tx generated every moment when the own vehicle 2A approaches a moving object 2B the target trajectory as illustrated in FIG. 2 but by making an event trajectory Tb as a moving object avoidance trajectory generated with predetermined treatment applied to an initially generated basic trajectory the target trajectory as illustrated in FIG. 3. According to this, the travel assistance system 1 may perform more appropriate travel assistance.

Specifically, the ECU 9 functionally and conceptually includes a driving assistance ECU 90 and a steering control ECU 91. The driving assistance ECU 90 and the steering control ECU 91 give/receive information such as a detection signal, the driving signal, and a control instruction to/from each other. Meanwhile, a travel control ECU which controls the travel of the vehicle 2 by controlling each unit of the vehicle 2 such as the steering actuator 12 of the steering device 4, the power source 6, and the brake actuator 14 of the braking device 8 may also serve as the steering control ECU 91. One ECU unit may serve as the driving assistance ECU 90 and the steering control ECU 91.

The driving assistance ECU 90 generates the target trajectory in the travel assistance. The steering control ECU 91 executes the steering control of the steering device 4 based on the target trajectory generated by the driving assistance ECU 90 to actually perform the travel assistance.

The driving assistance ECU 90 of this embodiment first generates the sequential trajectory as the basic avoidance trajectory for the vehicle 2 to travel while avoiding the moving object when the vehicle 2 approaches the moving object as the obstacle. Then, the driving assistance ECU 90 generates the event trajectory as the moving object avoidance trajectory based on the sequential trajectory. The driving assistance ECU 90 generates the event trajectory by enlarging the sequential trajectory in the travel direction of the vehicle 2 according to the relative speed of the vehicle 2 with respect to the moving object and makes the event trajectory the target trajectory. Then, the steering control ECU 91 controls the steering device 4 of the vehicle 2 based on the event trajectory (target trajectory) generated by the driving assistance ECU 90 to assist the travel of the vehicle 2.

Hereinafter, an example of the generation of the sequential trajectory is described with reference to FIG. 4, and thereafter, the generation of the event trajectory based on the sequential trajectory is described in more detail with reference to FIG. 5.

The driving assistance ECU 90 generates the sequential trajectory being the basis of the travel assistance based on the relative speed of the own vehicle with respect to the moving object, the relative distance therebetween, and the vehicle type of the moving object detected by the obstacle detecting device 17, the GPS information indicating the position of the own vehicle and the lateral distance between the white line of the own vehicle travel lane and the own vehicle detected by the own vehicle position detecting device 18, the infrastructure information (road information) stored in the database 21 and the like. The driving assistance ECU 90 generates the sequential trajectory for avoiding the moving object according to a momentary positional relationship between the vehicle 2 and the moving object when the vehicle 2 approaches the moving object in the travel direction and the obstacle detecting device 17 detects the moving object, for example, when generating the event trajectory.

FIG. 4 illustrates an example of the generation of the sequential trajectory by the driving assistance ECU 90. The driving assistance ECU 90 calculates a sequential trajectory Ta by dividing the same into three sections of sections A, B, and C in this order from a side of the own vehicle 2A as illustrated in FIG. 4, for example, when the own vehicle 2A approaches the moving object 2B in the travel direction and the obstacle detecting device 17 detects the moving object 2B.

The driving assistance ECU 90 sets a turning speed upper limit, a turning acceleration upper limit and the like according to the vehicle speed of the own vehicle 2A detected by the vehicle speed sensor 19 such that a curvature of the trajectory is not sharper than a predetermined curvature in consideration of the ride quality and the like when calculating the trajectory of the section A. The driving assistance ECU 90 sets a target lateral inter-vehicular distance Da being a target lateral inter-vehicular distance when the own vehicle 2A avoids the moving object 2B. Although the driving assistance ECU 90 may fix the target lateral inter-vehicular distance Da, this herein calculates the target lateral inter-vehicular distance Da based on the vehicle type of the moving object 2B detected by the obstacle detecting device 17, for example. A relationship between the target lateral inter-vehicular distance Da and the vehicle type is set in advance to be stored in a storage unit as a target lateral inter-vehicular distance map. The target lateral inter-vehicular distance Da is set to a relatively short distance when the moving object 2B is a small vehicle and set to a relatively long distance when the moving object 2B is a large vehicle, for example. The driving assistance ECU 90 calculates the target lateral inter-vehicular distance Da from the vehicle type of the moving object 2B detected by the obstacle detecting device 17 based on the target lateral inter-vehicular distance map. Then, the driving assistance ECU 90 subtracts an actual lateral inter-vehicular distance Db based on the lateral distance between the moving object 2B and the own vehicle 2A detected by the obstacle detecting device 17 from the calculated target lateral inter-vehicular distance Da to calculate a target lateral avoidance distance Dt (Dt=Da−Db). The target lateral avoidance distance Dt is a target lateral avoidance distance when the own vehicle 2A avoids the moving object 2B. Then, the driving assistance ECU 90 calculates a trajectory along which it is possible to move in parallel by the target lateral avoidance distance Dt in a shortest time laterally (herein, rightward) within a range of the turning speed upper limit, the turning acceleration upper limit and the like set above. At that time, the driving assistance ECU 90 sets an available trajectory according to a travel road on which the own vehicle 2A currently travels, the number of lanes and the like based on the map information such as the road information stored in the database 21. It is also possible that the driving assistance ECU 90 does not perform an event itself in which the own vehicle 2A avoids the moving object 2B when this cannot generate the available trajectory according to the travel road on which the own vehicle 2A currently travels, the number of lanes and the like.

The driving assistance ECU 90 calculates a vehicle total length of the moving object 2B based on the vehicle type of the moving object 2B detected by the obstacle detecting device 17 when calculating the trajectory of the section B. A relationship between the vehicle type and the vehicle total length is set in advance to be stored in the storage unit as a vehicle total length map. The driving assistance ECU 90 calculates the vehicle total length of the moving object 2B from the vehicle type of the moving object 2B detected by the obstacle detecting device 17 based on the vehicle total length map. Then, the driving assistance ECU 90 calculates a linear trajectory according to the calculated vehicle total length of the moving object 2B. The driving assistance ECU 90 calculates the linear trajectory twice or three times as long as the calculated vehicle total length of the moving object 2B, for example.

The driving assistance ECU 90 calculates the trajectory along which it is possible to move in parallel by the target lateral avoidance distance Dt in the shortest time laterally (herein, leftward) within the range of the turning speed upper limit, the turning acceleration upper limit and the like as in the section A when calculating the trajectory of the section C.

Then, the driving assistance ECU 90 calculates the sequential trajectory Ta by combining the trajectories calculated for the sections A, B, and C. The driving assistance ECU 90 may calculate the sequential trajectory Ta such that a joint between the trajectory of the section A and that of the section B and a joint between the trajectory of the section B and that of the section C, that is to say, the joints between the trajectory of a linear section and that of a curved section are joined by transient curves. The driving assistance ECU 90 stores the generated sequential trajectory Ta in the storage unit. At that time, the driving assistance ECU 90 may calculate a target longitudinal avoidance distance Lt. The target longitudinal avoidance distance Lt typically corresponds to a total length of the sequential trajectory Ta in the travel direction at the time of the event in which the own vehicle 2A avoids the moving object 2B.

Then, the driving assistance ECU 90 calculates the event trajectory from the sequential trajectory generated in the above-described manner to be stored in the storage unit. The driving assistance ECU 90 generates the event trajectory by enlarging the sequential trajectory in the travel direction of the vehicle 2 according to the relative speed of the vehicle 2 with respect to the moving object. In this embodiment, the driving assistance ECU 90 enlarges the sequential trajectory according to the vehicle speed of the vehicle 2 in addition to the relative speed of the vehicle 2 with respect to the moving object to generate the event trajectory. Although the above-described sequential trajectory is the trajectory generated for the vehicle 2 to avoid the moving object according to the momentary positional relationship between the vehicle 2 and the moving object, the event trajectory is the trajectory generated in block from start to end of the event in which the vehicle 2 avoids the moving object in the travel assistance based on the momentary sequential trajectory.

FIG. 5 illustrates an example of the generation of the event trajectory by the driving assistance ECU 90. When the driving assistance ECU 90 generates the sequential trajectory Ta, this generates the event trajectory Tb by enlarging the sequential trajectory Ta based on a vehicle speed V0 of the own vehicle 2A detected by the vehicle speed sensor 19 and a relative speed ΔV of the own vehicle 2A with respect to the moving object 2B detected by the obstacle detecting device 17. The relative speed ΔV used herein is a value obtained by subtracting a vehicle speed V1 of the moving object 2B from the vehicle speed V0 of the own vehicle 2A, that is to say, ΔV=V0−V1. Therefore, since a scene in which the own vehicle 2A approaches the moving object 2B is herein supposed, the relative speed ΔV basically is a positive value.

In more detail, the driving assistance ECU 90 enlarges the sequential trajectory Ta in the travel direction by a value obtained by dividing the vehicle speed V0 by the relative speed ΔV, that is to say, V0/ΔV, thereby generating the event trajectory Tb. Herein, the driving assistance ECU 90 generates the event trajectory Tb such that this has the same size as the sequential trajectory Ta in the lateral direction and is multiplied by [V0/ΔV] in the travel direction. That is to say, herein, the event trajectory Tb is generated such that an interval between the own vehicle 2A and the moving object 2B in the lateral direction is equivalent to that of the sequential trajectory Ta. Furthermore, the target lateral avoidance distance Dt in the event trajectory Tb is set to be equivalent to the target lateral avoidance distance Dt in the sequential trajectory Ta.

The driving assistance ECU 90 may calculate an event starting point S1, a catch-up point S2, an event completing point S3, a required distance for overtaking Lb in the event trajectory Tb by following equations (1) to (4). Herein, the event starting point S1 is a starting point of the event in which the own vehicle 2A avoids the moving object 2B. The catch-up point S2 is a point at which the own vehicle 2A catches up the moving object 2B. The event completing point S3 is a completing point of the event in which the own vehicle 2A avoids the moving object 2B. The required distance for overtaking Lb is a total length of the event trajectory Tb in the travel direction at the time of the event in which the own vehicle 2A avoids the moving object 2B, in other words, a distance from the event starting point S1 to the event completing point S3 in the travel direction. Furthermore, the required distance for overtaking Lb corresponds to the target longitudinal avoidance distance in the event trajectory Tb.

S1=(ΔL−Lt/2)·(V0/LV) (1)

S2=ΔL·(V0/ΔV) (2)

S3=(ΔL+Lt/2)·(V0/ΔV) (3)

Lb=Lt·(V0/ΔV) (4)

In equations (1) to (4), “V0” represents the vehicle speed of the own vehicle 2A, “ΔV” represents the above-described relative speed, “ΔL” represents the relative distance in the travel direction between the own vehicle 2A and the moving object 2B when the moving object 2B is detected, and “Lt” represents the target longitudinal avoidance distance in the above-described sequential trajectory. The vehicle speed V0 of the own vehicle 2A is detected by the vehicle speed sensor 19. The relative speed ΔV and the relative distance in the travel direction ΔL are detected by the obstacle detecting device 17. The target longitudinal avoidance distance Lt in the sequential trajectory is calculated based on the sequential trajectory generated by the driving assistance ECU 90. The driving assistance ECU 90 may calculate the event starting point S1, the catch-up point S2, the event completing point S3, and the required distance for overtaking Lb, for example, thereby specifying the event trajectory Tb generated by magnifying the sequential trajectory Ta by [V0/ΔV].

Meanwhile, in FIG. 5, a section A′ of the event trajectory Tb corresponds to an extended section of the section A of the sequential trajectory Ta. A section B′ of the event trajectory Tb corresponds to an extended section of the section B of the sequential trajectory Ta. A section C′ of the event trajectory Tb corresponds to an extended section of the section C of the sequential trajectory Ta.

The event trajectory Tb generated in the above-described manner is obtained by magnifying the sequential trajectory Ta by [V0/ΔV], so that this is a relatively long trajectory as an absolute value of the relative speed ΔV is relatively small and a relatively short trajectory as the absolute value of the relative speed ΔV is relatively large. That is to say, the driving assistance ECU 90 makes the event trajectory Tb relatively long in the travel direction of the own vehicle 2A as the absolute value of the relative speed ΔV is relatively small when the own vehicle 2A approaches the moving object 2B. On the other hand, the driving assistance ECU 90 makes the event trajectory Tb relatively short in the travel direction of the own vehicle 2A as the absolute value of the relative speed ΔV is relatively large. Herein, a case in which the absolute value of the relative speed ΔV is relatively small means that the own vehicle 2A relatively slowly approaches the moving object 2B. On the other hand, a case in which the absolute value of the relative speed ΔV is relatively large means that the own vehicle 2A relatively rapidly approaches the moving object 2B. Therefore, the driving assistance ECU 90 may make the event trajectory Tb relatively long in the travel direction of the own vehicle 2A as the own vehicle 2A relatively slowly approaches the moving object 2B and make the event trajectory Tb relatively short in the travel direction of the own vehicle 2A as the own vehicle 2A relatively rapidly approaches the moving object 2B.

Similarly, since the event trajectory Tb generated in the above-described manner is obtained by magnifying the sequential trajectory Ta by [V0/ΔV], this is the relatively long trajectory as the vehicle speed V0 of the own vehicle 2A is relatively high and the relatively short trajectory as the vehicle speed V0 of the own vehicle 2A is relatively low. That is to say, the driving assistance ECU 90 makes the event trajectory Tb relatively long in the travel direction of the own vehicle 2A as the vehicle speed V0 of the own vehicle 2A is relatively high when the own vehicle 2A approaches the moving object 2B. On the other hand, the driving assistance ECU 90 makes the event trajectory Tb relatively short in the travel direction of the own vehicle 2A as the vehicle speed V0 of the own vehicle 2A is relatively low.

Then, the steering control ECU 91 makes the event trajectory generated by the driving assistance ECU 90 the target trajectory and controls the steering device 4 of the vehicle 2 based on the event trajectory to assist the travel of the vehicle 2. Herein, the steering control ECU 91 calculates a target steering angle as a target control amount of the steering device 4 based on the event trajectory. The steering control ECU 91 calculates the target steering angle such that the actual travel trajectory of the vehicle 2 converges to the above-described generated event trajectory (target trajectory). Herein, the steering control ECU 91 may calculate the target steering angle by following equation (5) representing control logic, for example.

Target steering angle=FF(R,V)+FB(X,β) (5)

In equation (5), “FF(R,V)” represents a feedforward term in target steering angle calculation. The feedforward term FF(R,V) in the target steering angle calculation is a FF steering control amount calculated based on a curvature R at each point and the like of the target trajectory, herein, the event trajectory as illustrated in FIG. 6. The FF steering control amount is calculated based on the curvature R and the like of the event trajectory at the current position of the vehicle 2 detected by the own vehicle position detecting device 18 and the like. The FF steering control amount is calculated so as to be the steering angle according to the curvature R, the vehicle speed V and the like by using a vehicle model and the like. “FB(X,β)” represents a feedback term in the target steering angle calculation. The feedback term FB(X,β) in the target steering angle calculation is a FB steering control amount calculated based on a lateral deviation X and a directional deviation β of the position of the vehicle 2 relative to the target trajectory, herein, the event trajectory as illustrated in FIG. 6. The directional deviation β typically corresponds to an angle between a tangent line of the event trajectory and a center line in a front-rear direction of the vehicle 2. The FB steering control amount is calculated based on the lateral deviation X and the directional deviation β according to the current position and the like of the vehicle 2 detected by the own vehicle position detecting device 18. The FB steering control amount is calculated such that the lateral deviation X and the directional deviation β are 0.

The steering control ECU 91 controls the steering device 4 based on the target steering angle calculated according to the event trajectory, thereby assisting the travel of the vehicle 2. The steering control ECU 91 outputs the control instruction to the steering device 4 based on the control amount of the calculated target steering angle. That is to say, the steering control ECU 91 feedback controls such that an actual steering angle detected by the steering angle sensor 20 converges to the target steering angle and controls the steering device 4 such that the actual travel trajectory of the vehicle 2 converges to the above-described generated event trajectory.

Meanwhile, the ECU 9 of this embodiment may generate the sequential trajectory and the event trajectory again when a change amount of behavior of the moving object becomes not smaller than a change amount threshold set in advance while the steering control ECU 91 controls the steering device 4 of the vehicle 2 to assist the travel of the vehicle 2 based on the event trajectory generated by the driving assistance ECU 90. In this case, the ECU 9 may calculate the change amount of the behavior of the moving object based on the relative speed of the vehicle 2 with respect to the moving object, the relative distance therebetween and the like detected by the obstacle detecting device 17, for example. The above-described change amount threshold is a threshold set for the change amount of the behavior of the moving object for determining whether the moving object once detected by the obstacle detecting device 17 exhibits larger behavior than supposed. The change amount threshold is set in advance based on actual vehicle evaluation and the like, for example. The change amount threshold is set based on the change amount with which it is possible to discriminate lane change, rapid braking and the like of the moving object, for example, the change amount normally hardly generated at the time of the travel in the travel lane under a normal traffic condition. The driving assistance ECU 90 may generate the sequential trajectory again in accordance with the peripheral situation at the present time and generate the event trajectory again based on the sequential trajectory generated again as in the above when the change amount of the behavior of the moving object becomes not smaller than the change amount threshold.

Next, an example of the control by the ECU 9 is described with reference to the flowchart in FIG. 7. Meanwhile, this control routine is repeatedly executed at a control period of every few ms to every tens of ms (the same applies hereinafter).

First, the driving assistance ECU 90 of the ECU 9 determines whether event travel in which the own vehicle avoids the moving object is completed, in other words, whether it is not during the event travel (step ST1). The driving assistance ECU 90 may determine whether the event travel is completed by determining whether the own vehicle is within a section from the event starting point S1 to the event completing point S3 based on the position of the own vehicle detected by the own vehicle position detecting device 18, for example.

When the driving assistance ECU 90 determines that the event travel is completed, that is to say, it is not during the event travel at step ST1 (Yes at step ST1), this searches whether there is the moving object being a target of avoidance travel assistance of the own vehicle (step ST2). The driving assistance ECU 90 searches whether there is the moving object being the target based on the detection result and the like by the obstacle detecting device 17, for example.

The driving assistance ECU 90 determines whether there is the moving object being the target of the avoidance travel assistance of the own vehicle based on a search result at step ST2 (step ST3). When the driving assistance ECU 90 determines that there is no moving object being the target of the avoidance travel assistance (No at step ST3), this finishes a current control period and shifts to a next control period.

When the driving assistance ECU 90 determines that there is the moving object being the target of the avoidance travel assistance (Yes at step ST3), this recognizes a state of the moving object based on the detection result and the like by the obstacle detecting device 17 (step ST4). In this case, the driving assistance ECU 90 recognizes the relative speed of the own vehicle with respect to the moving object, the relative distance (relative distance in the travel direction and the lateral distance) therebetween, the vehicle type and the like, for example, as the state of the moving object.

Next, the driving assistance ECU 90 recognizes the state of the own vehicle based on the detection results and the like by the own vehicle position detecting device 18, the vehicle speed sensor 19, the steering angle sensor 20 and the like (step ST5). In this case, the driving assistance ECU 90 recognizes the vehicle speed of the own vehicle, the own vehicle position, the lateral deviation, the steering angle and the like, for example, as the state of the own vehicle.

Next, the driving assistance ECU 90 generates the sequential trajectory at the present time based on the state of the moving object recognized at step ST4, the state of the own vehicle recognized at step ST5, the map information (road information) stored in the database 21 and the like (step ST6). The driving assistance ECU 90 generates the sequential trajectory by the method illustrated in FIG. 4.

Next, the driving assistance ECU 90 generates the event trajectory based on the sequential trajectory generated at step ST6 (step ST7). The driving assistance ECU 90 generates the event trajectory by the method illustrated in FIG. 5.

Next, the steering control ECU 91 of the ECU 9 makes the event trajectory generated by the driving assistance ECU 90 at step ST7 the target trajectory and executes event travel control to control the steering device 4 of the vehicle 2 based on the event trajectory to assist the travel of the vehicle 2 (step ST8).

Then, the driving assistance ECU 90 determines whether the event travel is completed (step ST9) and shifts the procedure to step ST1.

When the driving assistance ECU 90 determines that the event travel is not completed, that is to say, it is during the event travel at step ST1 (No at step ST1), this measures the behavior of the moving object being the target of the avoidance travel assistance based on the detection result and the like by the obstacle detecting device 17 (step ST10).

The driving assistance ECU 90 determines whether it is required to change the trajectory based on the behavior of the moving object measured at step ST10 (step ST11). The driving assistance ECU 90 determines whether it is required to change the trajectory based on whether the change amount of the measured behavior of the moving object becomes not smaller than the change amount threshold set in advance.

When the driving assistance ECU 90 determines that it is required to change the trajectory, that is to say, the change amount of the behavior of the moving object becomes not smaller than the change amount threshold (Yes at step ST11), this shifts the procedure to step ST6.

When the driving assistance ECU 90 determines that it is not required to change the trajectory, that is to say, the change amount of the behavior of the moving object is smaller than the change amount threshold (No at step ST11), this shifts the procedure to step ST8.

The travel assistance system 1 configured in the above-described manner makes the event trajectory obtained by enlarging the sequential trajectory generated when the vehicle 2 approaches the moving object in the travel direction and the obstacle detecting device 17 detects the moving object according to the relative speed the target trajectory and assists the travel of the vehicle 2. According to this, the travel assistance system 1 may generate the event trajectory capable of avoiding the moving object by simpler logic by the ECU 9 as compared to a case in which the target trajectory is generated every moment for each control period according to the peripheral situation changing every moment, for example. As a result, the travel assistance system 1 may reduce the calculation load in the trajectory generation by the ECU 9.

The travel assistance system 1 may inhibit the calculation and generation of the target trajectory which is eventually not used, thereby inhibiting useless calculation, so that it is possible to inhibit efficiency of the calculation processing by the ECU 9 from being deteriorated. According to this, the ECU 9 may inhibit the number of times of comparatively complicated trajectory calculation and it is not required to make the ECU 9 excessively high-performance and high-cost for processing another function in parallel, for example, so that a lower manufacturing cost may be realized.

FIG. 8 is a schematic diagram comparing a case in which the travel assistance is performed based on the event trajectory Tb generated by the ECU 9 and a case in which the travel assistance is hypothetically performed based on the sequential trajectory Ta generated every moment for each control period. In FIG. 8, time and distance are represented along a horizontal axis and a vertical axis, respectively. FIG. 8 illustrates an example of a positional relationship between the own vehicle 2A and the moving object 2B when the travel assistance is performed based on the sequential trajectories Ta generated every moment from time t1 to time t7 on a left side according to time from time t1 to time t7. On the other hand, FIG. 8 illustrates an example of the positional relationship between the own vehicle 2A and the moving object 2B when the travel assistance is performed based on the event trajectory Tb on a right side according to time from time t1 to time t7.

The event trajectory Tb is macroscopically the trajectory obtained by combining and joining the sequential trajectories Ta generated every moment and eventually the trajectory substantially similar to the actual travel trajectory of the own vehicle 2A when the travel assistance is performed based on the sequential trajectories Ta generated every moment. On the other hand, in the event trajectory Tb, microscopically, a curvature R1 at each point is smaller than a curvature R0 at each point of the sequential trajectory Ta generated every moment, that is to say, this becomes the trajectory of a relatively shallow curve. Therefore, since the travel assistance system 1 performs the travel assistance of the own vehicle 2A based on the event trajectory Tb, the FF steering control amount in the control logic represented by equation (5) described above becomes relatively small as compared to the case of the travel assistance based on the sequential trajectory Ta generated every moment and slight variation of the FF steering control amount is inhibited. Herein, an effect of the FF steering control amount by the feedforward term FF(R,V) in the control logic represented by equation (5) described above basically tends to be larger than the effect of the FB steering control amount on the target steering angle calculated based on the target trajectory, that is to say, the effect of the curvature R of the trajectory described above tends to be larger. Therefore, the travel assistance system 1 may assist such that the own vehicle 2A more smoothly and more gradually travels along the event trajectory Tb as compared to the case of the travel assistance based on the sequential trajectory Ta generated every moment by performing the travel assistance of the own vehicle 2A based on the event trajectory Tb as described above. As a result, the travel assistance system 1 may also improve the ride quality.

The travel assistance system 1 makes the event trajectory Tb relatively long as the own vehicle 2A approaches the moving object 2B relatively slowly and makes the event trajectory Tb relatively short as the own vehicle 2A approaches relatively rapidly according to the relative speed of the own vehicle 2A with respect to the moving object 2B. As a result, the travel assistance system 1 may make the event starting point S1, the catch-up point S2, and the event completing point S3 farther points and ensure a relatively long bypassing portion (required distance for overtaking) in the event trajectory Tb in a case in which the own vehicle 2A approaches the moving object 2B slowly and time and travel distance required for avoiding become relatively long, for example. In contrast, the travel assistance system 1 may make the event starting point S1, the catch-up point S2, and the event completing point S3 closer points and make the bypassing portion (required distance for overtaking) in the event trajectory Tb relatively short in a case in which the own vehicle 2A approaches the moving object 2B rapidly and the time and the travel distance required for avoiding become relatively short, for example. As a result, the travel assistance system 1 may assist such that the own vehicle 2A may travel while more surely avoiding the moving object 2B according to the relative speed of the own vehicle 2A with respect to the moving object 2B.

The travel assistance system 1 makes the event trajectory Tb relatively long as the vehicle speed is relatively high and makes the event trajectory Tb relatively short as the vehicle speed is relatively low according to the vehicle speed of the own vehicle 2A. As a result, the travel assistance system 1 may make the event starting point S1, the catch-up point S2, and the event completing point S3 farther points and ensure the relatively long bypassing portion (required distance for overtaking) in the event trajectory Tb in a case in which the vehicle speed itself of the own vehicle 2A is high, for example. In contrast, the travel assistance system 1 may make the event starting point S1, the catch-up point S2, and the event completing point S3 closer points and make the bypassing portion (required distance for overtaking) in the event trajectory Tb relatively short in a case in which the vehicle speed itself of the own vehicle 2A is low, for example. As a result, the travel assistance system 1 may assist such that the own vehicle 2A may travel while more surely avoiding the moving object 2B according to the vehicle speed of the own vehicle 2A.

The travel assistance system 1 generates the sequential trajectory Ta and the event trajectory Tb again when the change amount of the behavior of the moving object 2B becomes not smaller than the change amount threshold while performing the travel assistance based on the event trajectory Tb. Therefore, in a state in which the change amount of the behavior of the moving object 2B is relatively small, the travel assistance system 1 may allow this to continue the travel assistance based on the event trajectory Tb. When the change amount of the behavior of the moving object 2B becomes relatively large, the travel assistance system 1 may generate the sequential trajectory Ta and the event trajectory Tb again according to this to start new travel assistance based on the event trajectory Tb generated again. As a result, the travel assistance system 1 may significantly reduce the number of times of generation of the sequential trajectory Ta and the event trajectory Tb to significantly reduce the calculation load, while this may perform the travel assistance by the event trajectory Tb generated again according to the situation when the behavior of the moving object 2B significantly changes.

According to the travel assistance system 1 according to the embodiment described above, the steering device 4 of the vehicle 2 and the ECU 9 which controls the steering device 4 of the vehicle 2 based on the event trajectory obtained by enlarging the sequential trajectory for the vehicle 2 to travel while avoiding the moving object in the travel direction of the vehicle 2 according to the relative speed of the vehicle 2 with respect to the moving object to assist the travel of the vehicle 2 are provided. Therefore, the travel assistance system 1 and the ECU 9 may satisfy both the reduction in the calculation load and the improvement in the ride quality by performing the travel assistance based on the event trajectory obtained by enlarging the sequential trajectory by the relative speed, thereby more appropriately performing the travel assistance.

Meanwhile, the ECU 9 stops assisting the travel of the vehicle 2 based on the event trajectory when presence of the oncoming vehicle traveling so as to be opposed to the vehicle 2 is predicted on the event trajectory based on the detection result and the like by the obstacle detecting device 17, for example. According to this, the travel assistance system 1 and the ECU 9 may further improve the safety at the time of the travel assistance.

### Second Embodiment

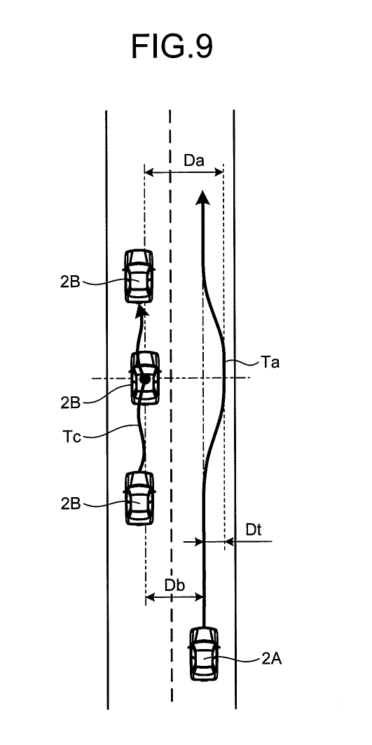

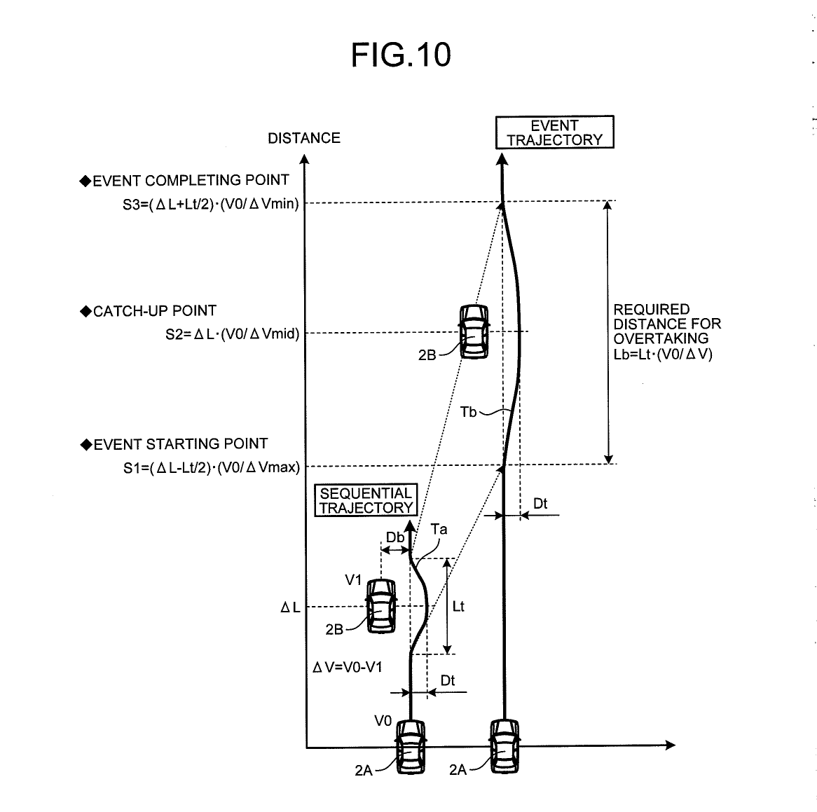

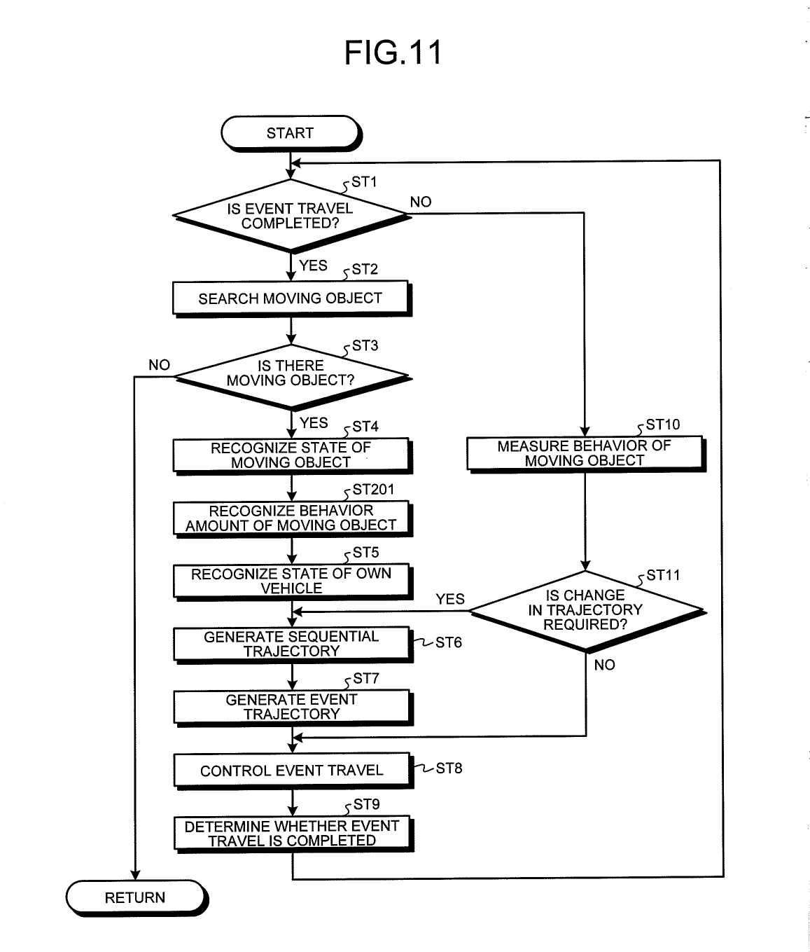

FIG. 9 is a schematic diagram illustrating an example of generation of a sequential trajectory in a travel assistance system according to a second embodiment. FIG. 10 is a schematic diagram illustrating an example of generation of an event trajectory in the travel assistance system according to the second embodiment. FIG. 11 is a flowchart illustrating an example of control by an ECU of the travel assistance system according to the second embodiment. The travel assistance system and a control device according to the second embodiment are partly different from those of the first embodiment in a method of generating a basic avoidance trajectory and a moving object avoidance trajectory. Overlapping description of a configuration, an action, and an effect the same as those of the above-described embodiment are not repeated as far as possible. As for each configuration of the travel assistance system and the control device according to the second embodiment, FIG. 1 and the like is appropriately referred to.

A travel assistance system 201 of this embodiment (refer to FIG. 1) incorporates a margin corresponding to an environmental change and the like into the event trajectory, for example. Specifically, the ECU 9 generates an event trajectory Tb based on behavior of a moving object 2B before a sequential trajectory Ta is generated as illustrated in FIGS. 9 and 10. As a result, the travel assistance system 201 may generate the event trajectory Tb corresponding to a change in behavior of the moving object 2B by incorporating the change corresponding to the change in behavior of the moving object 2B into the event trajectory Tb when generating the event trajectory Tb. According to this, the travel assistance system 201 tries to further improve safety and improve ride quality.

Herein, the ECU 9 finely adjusts the sequential trajectory Ta and the event trajectory Tb in a travel direction and a lateral direction of an own vehicle 2A based on the behavior of the moving object 2B before the sequential trajectory Ta is generated. A driving assistance ECU 90 generates the event trajectory Tb into which the change in behavior of the moving object 2B in the lateral direction described with reference to FIG. 9 below and the change in behavior of the moving object 2B in the travel direction described with reference to FIG. 10 are incorporated.

First, a case in which the change in behavior of the moving object 2B in the lateral direction is incorporated into the event trajectory Tb is described with reference to FIG. 9.

The driving assistance ECU 90 of the ECU 9 monitors the behavior of the moving object 2B before the sequential trajectory Ta is actually generated based on a detection result by an obstacle detecting device 17 and the like. The driving assistance ECU 90 measures rightward and leftward variation in the lateral direction of the moving object 2B based on an actual travel trajectory Tc of the moving object 2B before the sequential trajectory Ta is generated, for example. Then, the driving assistance ECU 90 makes a position at which the moving object 2B approaches the most a side on which the own vehicle 2A passes when the own vehicle 2A avoids the moving object 2B (right side in the example in FIG. 9) a reference position based on the measured rightward and leftward behavior in the lateral direction of the moving object 2B and makes the reference position a point of reference of a target lateral inter-vehicular distance Da. The driving assistance ECU 90 calculates a target lateral avoidance distance Dt based on the target lateral inter-vehicular distance Da from the reference position and an actual lateral inter-vehicular distance Db. In other words, the driving assistance ECU 90 subtracts a minimum value of the actual lateral inter-vehicular distance Db from the target lateral inter-vehicular distance Da to calculate the target lateral avoidance distance Dt. The minimum value of the actual lateral inter-vehicular distance Db is calculated based on the behavior of the moving object 2B detected by the obstacle detecting device 17 (behavior of the moving object 2B before the sequential trajectory Ta is actually generated). Then, the driving assistance ECU 90 calculates the sequential trajectory Ta based on the target lateral avoidance distance Dt based on a case in which the moving object 2B approaches the most the own vehicle 2A when the own vehicle 2A avoids the moving object 2B and generates the event trajectory Tb based on the sequential trajectory Ta. As a result, the driving assistance ECU 90 may generate the sequential trajectory Ta and the event trajectory Tb on a safest side in which the rightward and leftward behavior in the lateral direction of the moving object 2B before the sequential trajectory Ta is generated is reflected.

Next, a case in which the change in behavior of the moving object 2B in the travel direction (longitudinal direction) is incorporated into the event trajectory Tb is described with reference to FIG. 10.

The driving assistance ECU 90 monitors the behavior of the moving object 2B before the sequential trajectory Ta is actually generated based on the detection result by the obstacle detecting device 17 and the like. The driving assistance ECU 90 measures variation in vehicle speed in the travel direction of the moving object 2B based on the actual travel trajectory Tc of the moving object 2B before the sequential trajectory Ta is generated. The driving assistance ECU 90 calculates a relative speed maximum value ΔVmax, a relative speed minimum value ΔVmin, and a relative speed average value ΔVmid based on the measured forward and rearward behavior in the travel direction of the moving object 2B. Then, the driving assistance ECU 90 calculates an event starting point S1 by using the relative speed maximum value ΔVmax, calculates a catch-up point S2 by using the relative speed average value ΔVmid, and calculates an event completing point S3 by using the relative speed minimum value ΔVmin to generate the event trajectory Tb. As a result, the driving assistance ECU 90 may generate the event trajectory Tb on the safest side in which the variation in the vehicle speed of the moving object 2B in the travel direction of the moving object 2B before the sequential trajectory Ta is generated is reflected. Meanwhile, in this case, the driving assistance ECU 90 generates the event trajectory Tb based on the sequential trajectory Ta described with reference to FIG. 9 above. Therefore, the target lateral avoidance distance Dt of the event trajectory Tb is the target lateral avoidance distance Dt on the safest side in which the rightward and leftward behavior in the lateral direction of the moving object 2B before the sequential trajectory Ta is generated is reflected as described with reference to FIG. 9 above.

Next, an example of the control by the ECU 9 is described with reference to the flowchart in FIG. 11. Meanwhile, herein also, the description overlapping with that in FIG. 7 is not repeated as far as possible.

The driving assistance ECU 90 recognizes a behavior amount of the moving object before the sequential trajectory is actually generated based on the detection result by the obstacle detecting device 17 and the like (step ST201) after a process at step ST4. In this case, the driving assistance ECU 90 recognizes the relative speed maximum value, the relative speed minimum value, the relative speed average value, the minimum value of the actual lateral inter-vehicular distance and the like, for example, as the behavior amount of the moving object before the sequential trajectory is generated.

Then, the driving assistance ECU 90 generates the sequential trajectory and the event trajectory at the present time based on the behavior amount of the moving object recognized at step ST201 described above at steps ST6 and ST7. In this case, the driving assistance ECU 90 generates the sequential trajectory and the event trajectory by the method as illustrated in FIGS. 9 and 10.

The travel assistance system 201 and the ECU 9 according to the above-described embodiment may satisfy both reduction in calculation load and improvement in the ride quality by performing the travel assistance based on the event trajectory obtained by enlarging the sequential trajectory by the relative speed, thereby more appropriately performing the travel assistance.

Furthermore, according to the travel assistance system 201 according to the above-described embodiment, the ECU 9 generates the event trajectory based on the behavior of the moving object before the sequential trajectory is generated. Therefore, the travel assistance system 201 and the ECU 9 may generate the event trajectory corresponding to an estimated change in behavior of the moving object by incorporating the change in behavior of the moving object before the sequential trajectory is generated into the event trajectory, and according to this, the travel assistance system 201 may further improve the safety and the ride quality.

If the travel assistance system 201 and the ECU 9 reflect the behavior of the moving object before each sequential trajectory is generated into each sequential trajectory in the travel assistance based on the sequential trajectory generated every moment, the avoidance distance (avoidance time) and the like might become relatively long or a curvature of the trajectory might become relatively large because of the incorporated change in behavior. However, the travel assistance system 201 and the ECU 9 of this embodiment are configured to generate the event trajectory into which the change in behavior of the moving object is incorporated in block as described above, so that they may inhibit the avoidance distance (avoidance time) from being elongated and the curvature of the trajectory from becoming large because of the incorporated change in behavior.

Meanwhile, the travel assistance system 201 and the ECU 9 may further change the target lateral inter-vehicular distance Da itself based on the relative speed of the vehicle 2 with respect to the moving object detected by the obstacle detecting device 17. In this case, the ECU 9 may make the target lateral inter-vehicular distance (lateral margin) Da relatively large as the relative speed is relatively low, and generate the sequential trajectory and the event trajectory based on the target lateral inter-vehicular distance Da corrected according to the relative speed. That is to say, the ECU 9 may generate the event trajectory such that an interval between the vehicle 2 and the moving object in the lateral direction intersecting with the travel direction of the vehicle 2 becomes relatively wide as an absolute value of the relative speed of the vehicle 2 with respect to the moving object is relatively small when the vehicle 2 approaches the moving object. Other way round, the ECU 9 may generate the event trajectory such that the interval between the vehicle 2 and the moving object in the lateral direction becomes relatively narrow as the absolute value of the relative speed of the vehicle 2 with respect to the moving object is relatively large when the vehicle 2 approaches the moving object.

According to this, the travel assistance system 201 and the ECU 9 may make the interval between the vehicle 2 and the moving object in the lateral direction relatively wide when the relative speed is low and time for the vehicle 2 to pass the moving object is relatively long, so that it is possible to reduce uncomfortable feeling of a passenger when they travel side by side. On the other hand, the travel assistance system 201 and the ECU 9 may make the interval between the vehicle 2 and the moving object in the lateral direction relatively narrow when the relative speed is high and the time for the vehicle 2 to pass the moving object is relatively short, so that they may inhibit a moving amount of the vehicle 2 in the lateral direction, thereby improving the ride quality.

### Third Embodiment

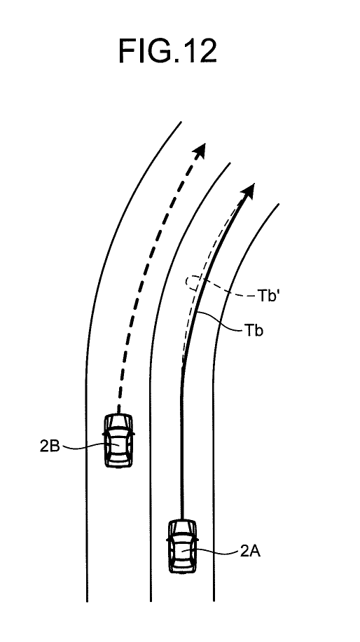

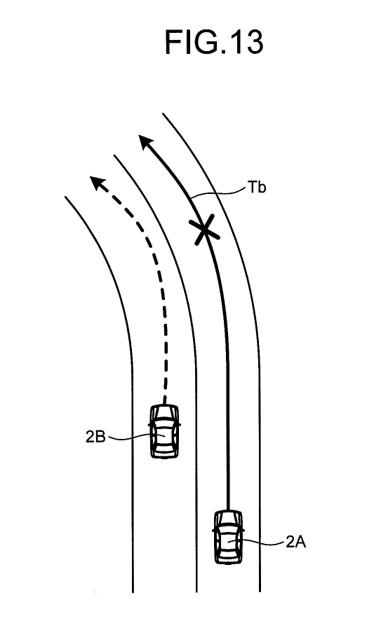

FIGS. 12 and 13 are schematic diagrams illustrating an example of an event trajectory in a travel assistance system according to a third embodiment. The travel assistance system and a control device according to the third embodiment are different from those of the first and second embodiments in that they change a moving object avoidance trajectory based on a travel road of a vehicle.

A travel assistance system 301 of this embodiment (refer to FIG. 1) changes the event trajectory based on the travel road of a vehicle 2, for example. Specifically, a driving assistance ECU 90 of an ECU 9 changes the event trajectory based on whether the travel road in a travel direction of an own vehicle 2A is a curved road as illustrated in FIGS. 12 and 13. The driving assistance ECU 90 may determine whether the travel road in the travel direction of the own vehicle 2A is the curved road based on a position of the own vehicle 2A detected by an own vehicle position detecting device 18 and map information (information of a road on which this will travel and the like) stored in a database 21, for example. The driving assistance ECU 90 changes an event trajectory Tb when determining that the travel road in the travel direction of the own vehicle 2A is the curved road.

For example, when the driving assistance ECU 90 determines that the travel road in the travel direction of the own vehicle 2A is a right-hand curved road, this changes to the event trajectory Tb into which a margin is incorporated according to the curve as illustrated in FIG. 12. An event trajectory Tb′ indicated by a dotted line in FIG. 12 is the trajectory into which the margin is not yet incorporated according to the curve and the event trajectory Tb indicated by a solid line is the trajectory into which the margin is incorporated according to the curve. The event trajectory Tb is the trajectory obtained by incorporating a predetermined margin into the event trajectory Tb′ on an inner side of a turn. A fixed value fixed in advance may be used as a predetermined margin or the margin may be changed according to a curvature of the curve and the like. The driving assistance ECU 90 makes the trajectory obtained by modifying the event trajectory Tb′ generated from a sequential trajectory so as to be arranged on the inner side of the turn the event trajectory Tb used as an actual target trajectory based on a fact that a moving object 2B tends to travel on the inner side of the turn in a case of the right-hand curved road illustrated in FIG. 12. According to this, the travel assistance system 301 may further improve safety. Meanwhile, in this case, the driving assistance ECU 90 may change the sequential trajectory itself by increasing a target lateral inter-vehicular distance Da, thereby changing the event trajectory Tb so as to be arranged on the inner side of the turn.

On the other hand, it is possible that the driving assistance ECU 90 does not perform an event itself in which the own vehicle 2A avoids the moving object 2B when determining that the travel road in the travel direction of the own vehicle 2A is a left-hand curved road as illustrated in FIG. 13. That is to say, in this case, it is possible that the driving assistance ECU 90 temporarily cancels the event trajectory Tb along which the own vehicle 2A avoids the moving object 2B and does not perform passing and the like. The driving assistance ECU 90 stops a passing event and allows the own vehicle 2A to wait based on a fact that the moving object 2B tends to travel in a manner veering outside the turn in the case of the left-hand curved road as illustrated in FIG. 13 and that a driver of the own vehicle 2A tends to have difficulty in seeing a situation of an area at which the vehicle arrives after passing in the case of the left-hand curved road. The driving assistance ECU 90 may generate the event trajectory Tb again as soon as the left-hand curved road ends to execute the passing event. According to this, it is possible that the travel assistance system 301 does not perform the travel assistance under a situation in which the situation of the area at which the vehicle arrives after the passing is hard to be seen, thereby preventing the driver from feeling uneasy as a result.

The travel assistance system 301 and the ECU 9 according to the above-described embodiment may satisfy both reduction in calculation load and improvement in ride quality by performing the travel assistance based on the event trajectory obtained by enlarging the sequential trajectory by a relative speed, thereby more appropriately performing the travel assistance.

Furthermore, according to the travel assistance system 301 according to the embodiment described above, the ECU 9 changes the event trajectory based on whether the travel road in the travel direction of the vehicle 2 is the curved road. Therefore, the travel assistance system 301 and the ECU 9 may change to the event trajectory into which it is incorporated whether the travel road is the curved road. As a result, the travel assistance system 301 and the ECU 9 may shorten a travel distance and improve fuel consumption performance while improving the safety in the right-hand curved road, for example, and may maintain excellent secure feeling of the driver by preventing forced travel assistance in the left-hand curved road in which the situation of the area at which the vehicle arrives after the passing is hard to be seen.

### Fourth Embodiment

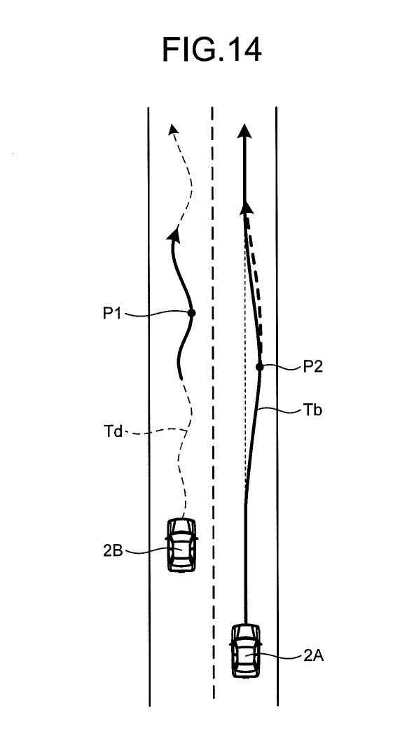

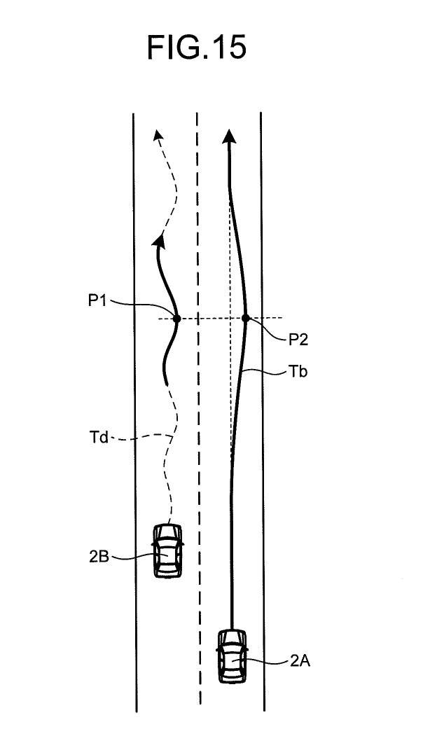

FIG. 14 is a schematic diagram illustrating an example of generation of an event trajectory in a travel assistance system according to a comparative example. FIG. 15 is a schematic diagram illustrating an example of generation of an event trajectory in a travel assistance system according to a fourth embodiment. The travel assistance system and a control device according to the fourth embodiment are different from those of the first, second, and third embodiments in that they generate a moving object avoidance trajectory based on prediction of behavior of an obstacle.

A travel assistance system 401 of this embodiment (refer to FIG. 1) tries to optimize timing of performing travel assistance based on the event trajectory by predicting the behavior of the moving object and incorporating the prediction into the event trajectory, for example.

Specifically, a driving assistance ECU 90 of an ECU 9 generates the event trajectory such that a closest position of the moving object to a vehicle 2 predicted based on the behavior of the moving object and a peak position of an avoidance trajectory along which the vehicle 2 avoids the moving object are equivalent positions in a travel direction of the vehicle 2.

For example, as illustrated in FIG. 14, there is a case in which it is preferable to modify an event trajectory Tb as follows when the closest position (right maximum point in FIG. 14) P1 of a moving object 2B to an own vehicle 2A in an actual travel trajectory Td of the moving object 2B and a peak position P2 of the avoidance trajectory along which the own vehicle 2A avoids the moving object 2B are displaced from each other. That is to say, there is a case in which it is preferable that a required distance for overtaking Lb (refer to FIG. 5 and the like) is elongated in advance or a portion corresponding to a section C′ (refer to FIG. 5 and the like) is modified according to the displacement between the closest position P1 and the peak position P2 of the avoidance trajectory as indicated by a dotted line in FIG. 14 in the event trajectory Tb. In this case, however, there is a case in which a travel distance for the own vehicle 2A to avoid the moving object 2B becomes relatively long or the event trajectory Tb has to be calculated again.

Therefore, the driving assistance ECU 90 of this embodiment predicts the behavior of the moving object 2B and generates the event trajectory Tb such that the closest position P1 and the peak position P2 of the avoidance trajectory are the equivalent positions in the travel direction of the own vehicle 2A based on the prediction as illustrated in FIG. 15. Herein, the peak position P2 of the avoidance trajectory typically corresponds to the above-described catch-up point.

The driving assistance ECU 90 monitors the behavior of the moving object 2B before a sequential trajectory Ta is actually generated based on a detection result by an obstacle detecting device 17 and the like, for example. Then, the driving assistance ECU 90 measures a lateral variation period and a lateral approaching position of the behavior of the moving object 2B based on the actual travel trajectory Td of the moving object 2B before the sequential trajectory is generated and predicts the behavior of the moving object 2B based on them. Then, the driving assistance ECU 90 generates the event trajectory Tb such that the closest position P1 of the behavior of the moving object 2B predicted based on the lateral variation period and the lateral approaching position and the peak position P2 of the avoidance trajectory in the event trajectory Tb are the equivalent positions in the travel direction. The driving assistance ECU 90 temporarily generates the event trajectory Tb by a method described with the above-described travel assistance systems 1, 201, 301 and the like, then displaces the peak position P2 of the avoidance trajectory in the event trajectory Tb to the closest position P1, thereby arranging the event trajectory Tb, for example. According to this, the driving assistance ECU 90 may generate a final event trajectory Tb in which the closest position P1 coincides with the peak position P2 of the avoidance trajectory. At that time, when there are two closest positions P1 in the vicinity of the peak position P2, the driving assistance ECU 90 may generate the event trajectory Tb such that the peak position P2 coincides with a farther closest position P1 from the own vehicle 2A out of the two closest positions P1. According to this, the driving assistance ECU 90 may generate the final event trajectory Tb by displacing the event trajectory Tb toward a safer side.

Meanwhile, control by the driving assistance ECU 90 is substantially similar to the control described with reference to FIG. 11. However, the driving assistance ECU 90 of this embodiment recognizes the lateral variation period, the lateral approaching position and the like of the behavior of the moving object in addition to a relative speed maximum value, a relative speed minimum value, a relative speed average value, a minimum value of an actual lateral inter-vehicular distance and the like, for example, as a behavior amount of the moving object before the sequential trajectory is generated at step ST201. Then, the driving assistance ECU 90 predicts the behavior of the moving object thereafter based on the lateral variation period, the lateral approaching position and the like of the behavior of the moving object. Then, the driving assistance ECU 90 generates the event trajectory such that the closest position and the peak position of the avoidance trajectory are the equivalent positions at step ST7.

The travel assistance system 401 and the ECU 9 according to the above-described embodiment may satisfy both reduction in calculation load and improvement in ride quality by performing the travel assistance based on the event trajectory obtained by enlarging the sequential trajectory by the relative speed, thereby more appropriately performing the travel assistance.

Furthermore, according to the travel assistance system 401 according to the above-described embodiment, the ECU 9 generates the event trajectory such that the closest position of the moving object to the vehicle 2 predicted based on the behavior of the moving object and the peak position of the avoidance trajectory along which the vehicle 2 avoids the moving object are the equivalent positions in the travel direction of the vehicle 2.

Therefore, the travel assistance system 401 and the ECU 9 may make the closest position of the moving object to the own vehicle coincide with the peak position of the avoidance trajectory, so that this may make a position at which the vehicle 2 and the moving object are side by side when the vehicle 2 avoids the moving object, in other words, the catch-up point coincide with the closest position. According to this, the travel assistance system 401 and the ECU 9 may generate an appropriate event trajectory according to the closest position of the moving object to the vehicle 2 while inhibiting the number of times of recalculation of the event trajectory and inhibiting the travel distance for the vehicle 2 to avoid the moving object from becoming longer. As a result, the travel assistance system 401 and the ECU 9 may inhibit increase in the calculation load, inhibit a curvature from locally becoming large in the event trajectory, and inhibit the travel distance when the vehicle 2 avoids the moving object, thereby improving fuel consumption performance.

### Fifth Embodiment

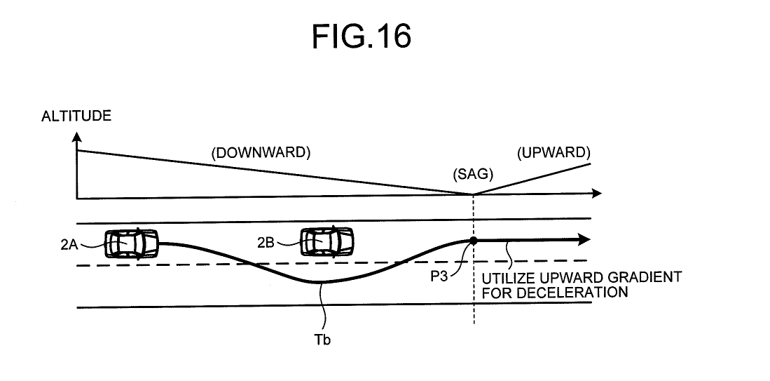

FIG. 16 is a schematic diagram illustrating an example of generation of an event trajectory in a travel assistance system according to a fifth embodiment. The travel assistance system and a control device according to the fifth embodiment are different from those of the first, second, third, and fourth embodiments in that they generate a moving object avoidance trajectory based on a shape of a travel road on which a vehicle travels and the like.

A travel assistance system 501 of this embodiment (refer to FIG. 1) tries to optimize timing of performing travel assistance based on the event trajectory by incorporating the shape of the travel road on which a vehicle 2 travels and the like into the event trajectory, for example.

Specifically, a driving assistance ECU 90 of an ECU 9 generates an event trajectory Tb such that a starting position P3 of an upward gradient of the travel road in a travel direction of an own vehicle 2A and an avoidance completing position of a moving object 2B by the own vehicle 2A are equivalent positions in the travel direction of the own vehicle 2A as illustrated in FIG. 16. Herein, in the example in FIG. 16, the starting position P3 of the upward gradient corresponds to a change point from a downward slope to an upward slope (sag) on the road. The avoidance completing position of the moving object 2B by the own vehicle 2A corresponds to the above-described event completing point.

The driving assistance ECU 90 recognizes the gradient of the travel road in the travel direction of the own vehicle 2A based on a position of the own vehicle 2A detected by an own vehicle position detecting device 18 and map information (road information and the like) stored in a database 21, for example. The driving assistance ECU 90 generates the event trajectory Tb such that the starting position P3 of the upward gradient and the avoidance completing position of the moving object 2B by the own vehicle 2A coincide with each other when determining that the travel road in the travel direction of the own vehicle 2A is the upward gradient. The driving assistance ECU 90 temporarily generates the event trajectory Tb by a method described with the above-described travel assistance systems 1, 201, and 301, for example, then displaces the avoidance completing position, that is to say, the event completing point in the event trajectory Tb to the starting position P3 of the upward gradient, thereby arranging the event trajectory Tb. According to this, the driving assistance ECU 90 may generate a final event trajectory Tb in which the starting position P3 of the upward gradient coincides with the avoidance completing position of the moving object 2B by the own vehicle 2A. At that time, the driving assistance ECU 90 does not have to forcedly make the starting position P3 of the upward gradient coincide with the avoidance completing position of the moving object 2B by the own vehicle 2A when the avoidance completing position (event completing point) of the initially generated event trajectory Tb is farther than the starting position P3 of the upward gradient. According to this, the driving assistance ECU 90 may generate the final event trajectory Tb into which the shape of the travel road on which the vehicle 2 travels and the like is incorporated only when the event trajectory Tb may be displaced toward a safer side.

Meanwhile, control by the driving assistance ECU 90 is substantially similar to the control described with reference to FIG. 11. However, the driving assistance ECU 90 of this embodiment recognizes the gradient of the travel road in the travel direction of the own vehicle 2 based on the position of the own vehicle detected by the own vehicle position detecting device 18 at step ST5 and the map information (road information and the like) stored in the database 21. Then, the driving assistance ECU 90 generates the event trajectory such that the starting position of the upward gradient and the avoidance completing position of the moving object by the vehicle 2 are the equivalent positions at step ST7 when there is the upward gradient in the travel road in the travel direction of the vehicle 2.

The travel assistance system 501 and the ECU 9 according to the above-described embodiment may satisfy both reduction in calculation load and improvement in ride quality by performing the travel assistance based on the event trajectory obtained by enlarging a sequential trajectory by a relative speed, thereby more appropriately performing the travel assistance.

Furthermore, according to the travel assistance system 501 according to the above-described embodiment, the ECU 9 generates the event trajectory such that the starting position of the upward gradient of the travel road in the travel direction of the vehicle 2 and the avoidance completing position of the moving object by the vehicle 2 are the equivalent positions in the travel direction of the vehicle 2.

The vehicle 2 often decelerates after passing the moving object, and the travel assistance system 501 and the ECU 9 may utilize the upward gradient for deceleration, for example. According to this, the travel assistance system 501 and the ECU 9 may inhibit the number of times of usage of a hydraulic braking unit 16 (refer to FIG. 1) of the vehicle 2 and inhibit abrasion of a pad and the like forming the hydraulic braking unit 16, for example.

Meanwhile, the travel assistance system and the control device according to the above-described embodiments of the present invention are not limited to those of the above-described embodiments and may be variously modified within the scope of claims. The travel assistance system and the control device according to the embodiments may also be formed by appropriate combination of the components of each of the above-described embodiments.

The steering device 4 described above may be a so-called steer-by-wire type without mechanical connection between the steering wheel 10 and the steered wheel.

Although it is described above that the driving assistance ECU 90 enlarges the sequential trajectory to generate the event trajectory according to the vehicle speed of the vehicle 2 and the relative speed of the vehicle 2 with respect to the moving object, there is no limitation. The driving assistance ECU 90 may enlarge the sequential trajectory according to the relative speed of the vehicle 2 with respect to the moving object to generate the event trajectory irrespective of the vehicle speed of the vehicle 2.

### REFERENCE SIGNS LIST

1, 201, 301, 401, 501 TRAVEL ASSISTANCE SYSTEM
2 VEHICLE
2A OWN VEHICLE
2B MOVING OBJECT (OBSTACLE)
4 STEERING DEVICE (ACTUATOR)
6 POWER SOURCE
8 BRAKING DEVICE
9 ECU (CONTROL DEVICE)
12 STEERING ACTUATOR
17 OBSTACLE DETECTING DEVICE
18 OWN VEHICLE POSITION DETECTING DEVICE
19 VEHICLE SPEED SENSOR
20 STEERING ANGLE SENSOR
21 DATABASE
90 DRIVING ASSISTANCE ECU
91 STEERING CONTROL ECU
P1 CLOSEST POSITION
P2 PEAK POSITION OF AVOIDANCE TRAJECTORY
P3 STARTING POSITION OF UPWARD GRADIENT

1. A travel assistance system comprising:
an actuator of a vehicle; and
a control device configured to control the actuator of the vehicle, to assist travel of the vehicle, based on a moving object avoidance trajectory obtained by enlarging, in a travel direction of the vehicle, a basic avoidance trajectory for the vehicle to travel while avoiding an obstacle according to a relative speed of the vehicle with respect to the obstacle.

2. The travel assistance system according to claim 1, wherein the control device is configured to make the moving object avoidance trajectory relatively long in the travel direction of the vehicle as an absolute value of the relative speed is relatively small at a time the vehicle approaches the obstacle.

3. The travel assistance system according to claim 1, wherein the control device is configured to generate the moving object avoidance trajectory by enlarging the basic avoidance trajectory according to a vehicle speed of the vehicle and the relative speed.

4. The travel assistance system according to claim 3, wherein the control device is configured to make the moving object avoidance trajectory relatively long in the travel direction of the vehicle as the vehicle speed of the vehicle is relatively high at a time the vehicle approaches the obstacle.

5. The travel assistance system according to claim 1, wherein the control device is configured to generate the moving object avoidance trajectory based on behavior of the obstacle before the basic avoidance trajectory has been generated.

6. The travel assistance system according to claim 1, wherein the control device is configured to generate the basic avoidance trajectory again and generate the moving object avoidance trajectory again based on the basic avoidance trajectory generated again at a time a change amount of the behavior of the obstacle becomes not smaller than a change amount threshold set in advance while controlling the actuator of the vehicle based on the moving object avoidance trajectory to assist the travel of the vehicle.

7. The travel assistance system according to claim 1, wherein the control device is configured to generate the moving object avoidance trajectory such that an interval between the vehicle and the obstacle becomes relatively wide in a direction intersecting with the travel direction of the vehicle as the absolute value of the relative speed is relatively small when the vehicle approaches the obstacle.

8. The travel assistance system according to claim 1, wherein the control device is configured to change the moving object avoidance trajectory based on whether or not a travel road in the travel direction of the vehicle is a curved road.

9. The travel assistance system according to claim 1, wherein the control device is configured to stop assisting the travel of the vehicle based on the moving object avoidance trajectory at a time presence of an oncoming vehicle traveling so as to be opposed to the vehicle is predicted on the moving object avoidance trajectory.

10. The travel assistance system according to claim 1, wherein the control device is configured to generate the moving object avoidance trajectory such that a closest position of the obstacle to the vehicle predicted based on the behavior of the obstacle and a peak position of an avoidance trajectory along which the vehicle avoids the obstacle are equivalent positions in the travel direction of the vehicle.

11. The travel assistance system according to claim 1, wherein the control device is configured to generate the moving object avoidance trajectory such that a starting position of an upward gradient of the travel road in the travel direction of the vehicle and an avoidance completing position of the obstacle by the vehicle are equivalent positions in the travel direction of the vehicle.

12. The travel assistance system according to claim 1, wherein the control device is configured to generate the basic avoidance trajectory based on a momentary positional relationship between the vehicle and the obstacle before the moving object avoidance trajectory is generated.

13. A control device configured to control a vehicle, to assist travel of the vehicle, based on a moving object avoidance trajectory obtained by enlarging, in a travel direction of the vehicle, a basic avoidance trajectory for the vehicle to travel while avoiding an obstacle according to a relative speed of the vehicle with respect to the obstacle.
